(19) United States
(12) Patent Application Publication
(10) Pub. No.: US 2012/0180723 A1
(43) Pub. Date: Jul. 19, 2012

(54) METHOD FOR CONTROLLING THE FUNCTION OF A ROTARY ATOMIZER AND CORRESPONDING COATING INSTALLATION

(76) Inventors: Harald Gummlich, Ludwigsburg (DE); Hans-Jurgen Nolte, Besigheim (DE)

(21) Appl. No.: 13/498,250

(22) PCT Filed: Sep. 21, 2010
(86) PCT No.: PCT/EP2010/005774

§ 371 Date: Mar. 26, 2012

(30) Foreign Application Priority Data
Sep. 24, 2009 (DE) 10 2009 042 955.7

(51) Int. Cl. B05C 11/06; G01F 1/36

(52) U.S. Cl. 118/712; 73/196

(57) ABSTRACT

Exemplary illustrations of a rotary atomizer and methods of using the same are disclosed. An exemplary illustration is directed to the function control of a rotary atomizer used for the serial coating of work pieces. This is achieved in that pressure values, which result within or outside of the directing air flow of the atomizer, may be measured and compared to predefined reference values for error-free atomizer functions.

### CROSS-REFERENCES TO RELATED APPLICATIONS

This application is a National Stage application which claims the benefit of International Application No. PCT/EP2010/005774 filed Sep. 21, 2010, which claims priority based on German Application No. DE 10 2009 042 955.7, filed Sep. 24, 2009, both of which are hereby incorporated by reference in their entireties.

### BACKGROUND

The present disclosure relates to a method for function checking of a rotary atomizer, e.g. mounted on a painting robot, such as for electrostatic series coating of workpieces such as notably vehicle bodies, as well as a corresponding coating installation.

High-speed rotary atomizers of the type considered here may generally include a rotating bell cup as spray body and the drive thereof. For the most part, air-cushioned air turbines are used as drive. Depending on the paint material and throughput quantities, the atomizers are operated at rotary speeds between approximately 5000 and 100000 rpm. The paint spun off tangentially by the bell cup and atomized is deflected and shaped to form a spray jet by means of a directing air flow which exits coaxially to the atomizer axis from bore or annular-gap arrangements arranged downstream of the bell cup (e.g., see EP 1 331 037 B1, WO 2008/061584 A1 and corresponding U.S. Pat. No. 8,097,293), as well as by means of electrostatic field forces onto the earthed substrate to be coated. With directing air, an additional secondary paint atomization is also effected at the bell cup edge. The directing air quantity may be controlled as a function of target values.

In the case of the industrial paint coating carried out with atomizers of this type, generally the most important quality criteria are the layer thickness and the evenness of the applied paint layer. The quality requirements increase further with the desire for constantly increasing productivity and higher area outputs without quality losses and also with the availability of improved paint materials. The required layer evenness has hitherto been achieved inter alia, because the paint is applied in a plurality of overlapping layers. In future processes with less outlay or with increasing of the productivity by means of higher painting speeds, correspondingly higher requirements on the quality of the layers will arise.

The resulting layer thickness depends substantially in the case of high-rotation atomization on the area distribution of the paint on the basis of the width of the spray jet. As the area of the paint application decreases in a quadratic ratio with reduction of the spray jet width, given a constant paint quantity, the layer thickness increases in the inverse ratio, so that variations of the layer thickness of several 100% are possible and to some extent are also used. The spray jet width definitive for the layer formation is for its part controlled by the direction and speed of the previously mentioned directing air flow. In the case of an incorrect air flow, undesired deviations from the desired layer formation result. While too thick a layer results in the case of too strong a constriction of the spray jet on too small an area, the reverse case arises in the case of too weak a constriction of the spray jet. Further, the cross-sectional shape of the applied layer is distorted by means of undesired directing air flows.

In the case of the overwhelming majority of rotary atomizers conventional in practice, the point of impact of the paint particles on the workpiece is not located on the extended rotational axis of the bell cup, that is to say the central axis of the air nozzles concentric thereto. Further, the spray jet width can change independently of the position of the air nozzle axes and the bell cup shape, because the directing air flowing out of a multiplicity of individual nozzles at high speed generates a considerable friction at the outer and inner curved surfaces thereof with respect to the resting ambient air and therefore moves parts of the ambient air in a direction parallel to the directing air. While the resultant air deficits at the outer curved surface can easily be compensated by means of the inflow of ambient air, a underpressure forms in the interior of the directing air cone, which leads to the deformation, i.e. focusing of the ambient air cone. This deformation then determines the spray jet width.

The spray jet width may be set during the coating process by means of the closed-loop controlled directing air flow in accordance with the respective specifications with respect to workpiece geometry and process conditions. This desired controllability of the spray jet width depends substantially on the underpressure which can be achieved within the flow cone. The higher flow speeds required to this end also effect a better deflection of the paint particle flow at the bell cup edge. To a large extent, the directing air internal pressure is therefore a function-determining criterion for the transporting and the local deposition of the paint particle flow. Normally, the internal pressure represents the directing air quantity, the flow speed and the flow geometry.

Furthermore, the directing air internal pressure and the directing air/internal pressure characteristic, that is to say the progression of the internal pressure of the directing air flow as a function of the directing air quantity measured per unit of time, are also an identification criterion for the flawless state of the directing air nozzle arrangement of the atomizer, particularly of the opening cross section, the geometric uniformity and correct installation of the bores or slots of the directing air ring, which, in addition to manufacturing tolerances, damage or installation faults, such as e.g. swapping of two different directing air circuits present or missing or defective seals in the atomizer, can also be impaired by contamination. The effect on the directing air internal pressure, which is reduced by all faults of this type, is based substantially on the possibilities present for a compensation of the high pressure difference between the external and internal pressure. Unequal discharge speeds and air quantities from individual directing air nozzles mean different kinetic energy. The directing air is therefore deflected differently by means of the acting pressure forces, i.e. weak points arise in the directing air cone, which constitute potential passages for pressure equalisation. Even slight geometric irregularities of the nozzle bores likewise lead, with increasing distance from the bore, to weak points in the directing air cone. Further, irregularities in the flow geometry can lead, depending on the movement direction and speed of the flow, to air passage and to a corresponding pressure equalisation with effects on the spay jet width.

To some extent, the pressure difference is also compensated by air inflow from the overpressure zone upstream of the workpiece surface, as a result of which the spray cone can become wider. With reduction of the flow resistance of the workpiece surface, the overpressure and thus the mentioned air inflow are reduced, so that the correspondingly sinking internal pressure leads to a “collapse” of the spray jet and therefore to clearly smaller jet diameters. In individual cases, a halving of the jet diameter and therefore a quadrupling of the local paint deposition is to be observed. Although this effect can be useful in certain cases, it is undesirable if it starts in an incalculable manner.

The above-mentioned effects can lead to undesired reproducibility faults and quality defects during the commissioning of the coating installation and in the production process. All of the diagnostics options existing hitherto for preventing defects of this type, for example with area flow measurement systems, are extremely complex and/or require interventions into the atomization system, such as e.g. separation of the air supply for installing a flow meter or can only be carried out by checking individual components and individual functions. Further, changes of the atomizer, for example due to contamination of the directing air bores, incorrect component installation, etc., which are decisive for the function due to later faults in production operation, particularly during maintenance and cleaning operations, are not excluded. If wear or damage to components is not detected due to a lack of a clear diagnosis, coating operation is continued with quality losses. Also a check of the completely installed atomizer when the coating installation is commissioned, by means of painting experiments is temporally and technically involved and tied to a range of basic conditions (often reference spray patterns are not available for the respective paint material, plates must be burnt in a dryer and measured by machine, to the greatest possible extent, etc.). Further, painted spray patterns, such as e.g. brush profiles as a testing method for quality control are not only merely dependent on the atomizer function, but rather additionally on a multiplicity of varying factors such as properties and temperature of the paint material and other boundary conditions. In addition, changes due to contamination, leaks, incorrect or defective components, etc. are often recognised here too late and often only by means of complaints about the coating quality.

Accordingly, there is a need for a method and an associated coating installation, respectively, with which a virtually entire function check of rotary atomizers is possible in a simple, objective and reliable manner with little outlay both before and during the coating operation (on-line).

### BRIEF DESCRIPTION OF THE FIGURES

While the claims are not limited to the specific illustrations described herein, an appreciation of various aspects is best gained through a discussion of various examples thereof. Referring now to the drawings, illustrative examples are shown in detail. Although the drawings represent the exemplary illustrations, the drawings are not necessarily to scale and certain features may be exaggerated to better illustrate and explain an innovative aspect of an illustration. Further, the exemplary illustrations described herein are not intended to be exhaustive or otherwise limiting or restricting to the precise form and configuration shown in the drawings and disclosed in the following detailed description. Exemplary illustrations are described in detail by referring to the drawings as follows:

FIG. 1 illustrates a flow field at an end face of a rotary atomizer, according to an exemplary illustration;

FIG. 2 illustrates possible locations for the positioning of pressure sensors in the rotary atomizer and outside in the underpressure regions of the directing air flow thereof, according to an exemplary illustration; and

FIG. 3 illustrates examples for the positioning of pressure sensors outside of the rotary atomizer, according to an exemplary illustration.

### DETAILED DESCRIPTION

The exemplary illustrations are generally based on the recognition that a high and stable pressure difference between the pressure regions inside and outside of the air directing air flow is a clear characteristic for a faultless overall system of the rotary atomizer. The same applies for a steep long directing air/internal pressure characteristic. It may also be sufficient to only measure the internal pressure of the directing air flow or the pressure in the underpressure region adjoining the directing air flow outside, that is to say the pressure difference compared to the known air pressure in the surroundings of the atomizer.

As has already been mentioned at the beginning, the directing air flow here may be, in one example, a gas flow generated in any manner that is convenient, e.g., by the atomizer with an arrangement of directing air openings or nozzles of the atomizer, whereby it could be possible in theory to also use another gas instead of air. It is therefore the (typically more or less conical) flow at the front outside of the atomizer, to which the coating material sprayed by the rotating bell cup of the atomizer is subjected.

The respective pressure can be measured with the aid, under certain circumstances, of only one, but in any case fewer pressure gauges and correspondingly low outlay, e.g., with pressure sensors which can be installed fixedly in the interior and/or outside of the atomizer or can also be movable outside of the atomizer. In the case of external sensors, the rotary atomizer or the pressure sensor can be brought into a predetermined defined measuring position, whereby the rotary atomizer is positioned for example by the painting robot on which it is mounted, whilst a movable sensor can be positioned for example manually or also by an in particular automatically controlled handling device or auxiliary robot.

For measuring, a directing air flow is generated with defined air quantities per unit of time, in the case of a plurality of simultaneously generated different directing airs, with defined air quantity combinations. The pressure values resulting here in the outer and/or inner underpressure region are compared with associated stored set points for the ideal or flawless state and correspondingly evaluated. In addition, a plurality of different air quantities are set for checking.

A particular advantage of the underpressure measurement, according to one exemplary illustration, is being able to characterise the essential atomizer functions, such as directing air quantity, geometry of the directing air nozzles and real fault situation even without simultaneous paint atomization, that is to say without influence by means of properties of the coating material and without corresponding disadvantages such as contamination, cleaning, disposal, etc. The measurement may take place manually or, in another exemplary illustration, fully automatically without intervention in the atomizer and in the supply line system thereof. The measurement information may also be always immediately available, so that in the case of a fault, suitable measures can be introduced generally immediately and consequently, for example for production checking when commissioning the coating installation and in particular also when the production process is running (on-line), quality defects of coated workpieces and corresponding costs due to malfunctions can be prevented. The production quality is therefore supported preventatively, specifically in a substantially more objective manner than in practice up to now, particularly independently of subjective factors such as qualification and availability of skilled personnel. The measured values are also independent of a particular test set up and test location and therefore objective and comparable with one another.

Furthermore, additional advantages arise, such as for example the possibility of a fast fault assignment by means of varying test conditions such as for example the creation of characteristics, diverting the two directing airs present, etc. Further, defective components of the atomizer can be detected and exchanged immediately.

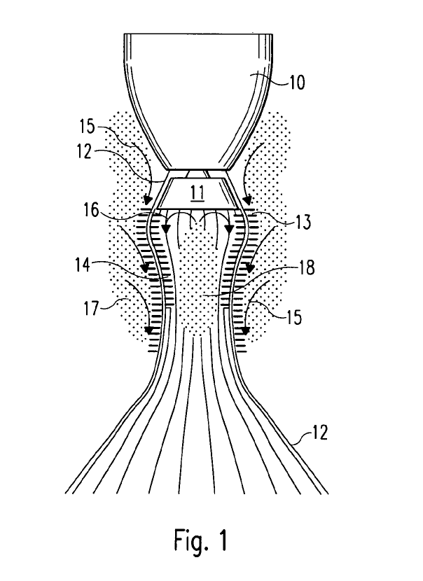

The front part of a rotary atomizer 10 facing the coated workpiece is shown schematically in FIG. 1. The rotary atomizer 10 includes a bell cup 11 and a directing air ring which is not shown in detail. The arrangement of directing air nozzles of the air ring (not shown) may be concentric to the rotational axis and may generate the directing air flow 12 in any manner that is convenient. The shape of the paths of the paint particles sprayed tangentially by the bell cup 11, that is to say of the spray jet, may correspond to the directing air cone represented. The rotary atomizer 10 can be of any desired type and in particular conventional type for car body painting (e.g., the above-mentioned WO 2008/061584 A1 and corresponding U.S. Pat. No. 8,097,293) and therefore does not require any further description.

As has already been mentioned, when the directing air flow 12 is generated, due to the friction between the fast flowing directing air and the previously resting ambient air, an outer air friction region 13 may form at the outer surface of the directing air flow 12 and an inner air friction region 14 may form at the internal surface thereof, as a result of which, outside of the directing air flow, in the vicinity thereof, an outer underpressure region 17 is formed and within the directing air flow, the inner underpressure region 18 required for the desired focussing of the flow is formed. Partial pressure equalisation takes place by means of an outer equalisation flow indicated at 15 and an inner equalisation flow 16.

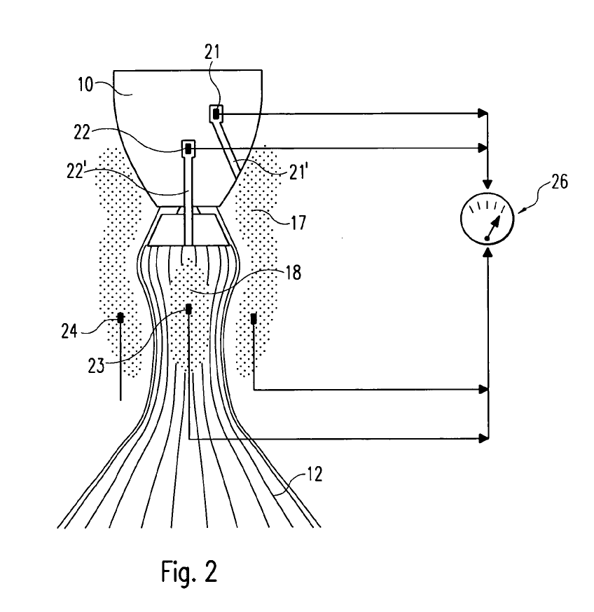

For measurement, according to one exemplary illustration, of the pressure values in the underpressure regions 17 and/or 18, in principle any desired measuring apparatuses can be used. A few exemplary illustrations for suitable locations for positioning pressure sensors are represented in FIG. 2. Accordingly, it may be expedient to fixedly install a pressure sensor 21 in the rotary atomizer 10 for measuring the outer underpressure and/or a pressure sensor 22 for measuring the internal underpressure of the directing air flow 12. Here, the sensors are connected to the underpressure regions 17 and/or 18 by corresponding pressure measurement channels 21′ or 22′, of which the channel 21′ can open according to the representation in the vicinity of the bell cup in the circumferential surface of the atomizer housing, whilst the channel 22′ e.g. can open centrally in the end face of the bell cup which faces the workpiece and can there match the paint outlet path, through which, in one exemplary illustration, no paint flows during the pressure measurement. In addition to the pressure sensors 21 and 22 or instead of the same, external pressure sensors 23 and 24 can be arranged outside of the rotary atomizer 10 directly in the underpressure regions 17 and 18 for measuring the respective pressure there.

The pressure values measured by the sensors 21-24 can be supplied in the form of suitable signals to a schematically represented measuring system 26, evaluated and compared with predetermined reference values for ideal or flawless atomizer functions. For problem-free transmission out of the high-voltage region of the electrostatic rotary atomizer 10, the measured values of the pressure sensors 21 and 22 can in particular be transmitted as pneumatic signals to the measurement system 26.

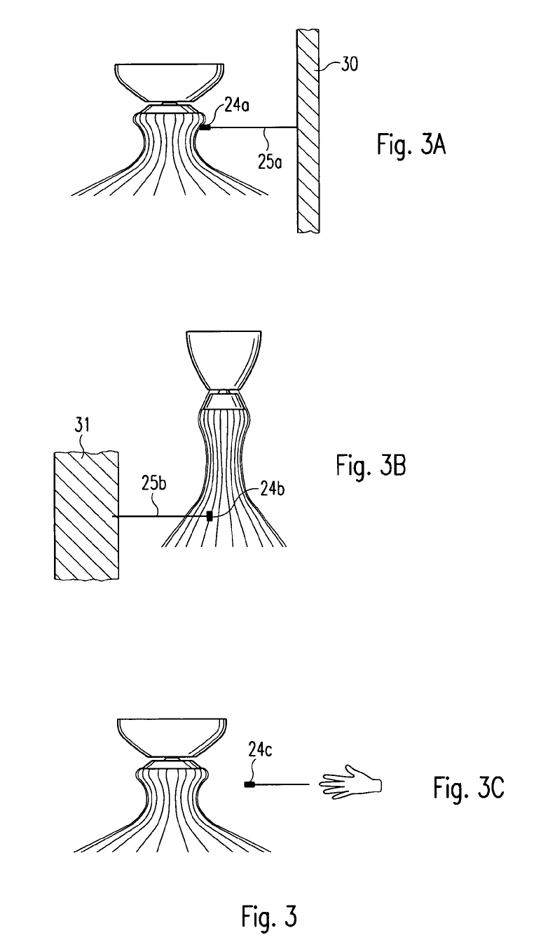

Various possibilities for the arrangement of external pressure sensors 23 or 24 (FIG. 2) in the underpressure regions mentioned are represented by way of example in FIG. 3. As a first example, the representation 3A shows a pressure sensor 24a, which, particularly for the measurement of the outer underpressure, can be installed expediently with a spacer 25a fixedly on the wall 30 of the spray booth or on another fixed constituent of the coating installation considered here, which is defined in terms of its position. To measure the pressure value, the rotary atomizer can, in one exemplary illustration, automatically be brought into the correct measurement position relative to the defined position of the pressure sensor 24a by its painting robot.

The representation 3B shows an external pressure sensor 24b, which likewise can be installed, particularly for measuring the outer underpressure, fixedly and expediently with a spacer 25b on a part 31 of the painting robot itself, that is to say in particular on a part of defined position, which can be reached with the forearm and wrist of the robot.

The representation 3C by contrast shows a manually movable and, in one exemplary illustration, transportable pressure probe 24c, which for example can be introduced into the directing air flow for measuring the pressure in the inner underpressure region of the directing air flow. As has already been mentioned, in one exemplary illustration an automatically controlled handling device can also be used for this however.

It is expedient to protect the pressure probes from direct back-pressure action of the high speeds of flow of the directing air. An expedient possibility therefor is for example enclosing the pressure sensors with air permeable, but flow-interrupting sintered bodies made of metal or plastic. Incidentally, any known pressure probes that are convenient, e.g., a conventional pressure probe, can be used.

One exemplary illustration is directed to a regular or periodic contamination check in the production process. A contamination with caked-on paint mist can change the opening cross section of directing air nozzles in such a manner that a weakening or directional change of the air discharge takes place. The weakening of the desired directing air flow effects a reduction of the underpressure in the interior of the directing air flow, as a result of which the focusing of the paint flow in the direction of the workpiece is weakened and thus the spray jet width is reduced. Consequently, the distribution of the paint deposition on the workpiece broadens with correspondingly smaller layer thickness. In the edge regions of the workpiece, higher boundary losses occur in terms of paint material, because parts of the droplet flow miss the surface. To diagnose malfunctions of this type, the atomizer can be advanced at regular time intervals, for example, by the painting robot to a fixedly installed pressure sensor, such as 23 in FIG. 2, in such a manner that the internal pressure in the directing air flow can be measured. If the set points for flawless atomizer function have previously been measured and stored, a later comparison with the current states to be tested and therefore the detection of faults and the introduction of suitable measures for overcoming faults are possible, in the example considered, for cleaning the directing air nozzles.

The exemplary illustrations are not limited to the previously described examples. Rather, a plurality of variants and modifications are possible, which also make use of the ideas of the exemplary illustrations and therefore fall within the protective scope. Furthermore the exemplary illustrations also include other useful features, e.g., as described in the subject-matter of the dependent claims independently of the features of the other claims.

Reference in the specification to “one example,” “an example,” “one embodiment,” or “an embodiment” means that a particular feature, structure, or characteristic described in connection with the example is included in at least one example. The phrase “in one example” in various places in the specification does not necessarily refer to the same example each time it appears.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain examples, and should in no way be construed so as to limit the claimed invention.

Accordingly, it is to be understood that the above description is intended to be illustrative and not restrictive. Many examples and applications other than those specifically provided would be evident upon reading the above description. The scope of the invention should be determined, not with reference to the above description, but should instead be determined with reference to the appended claims, along with the full scope of equivalents to which such claims are entitled. It is anticipated and intended that future developments will occur in the arts discussed herein, and that the disclosed systems and methods will be incorporated into such future examples. In sum, it should be understood that the invention is capable of modification and variation and is limited only by the following claims.

All terms used in the claims are intended to be given their broadest reasonable constructions and their ordinary meanings as understood by those skilled in the art unless an explicit indication to the contrary is made herein. In particular, use of the singular articles such as “a,” “the,” “the,” etc. should be read to recite one or more of the indicated elements unless a claim recites an explicit limitation to the contrary.

1. A method for function checking of a rotary atomizer used for the series coating of workpieces, which has a rotating spray body, which is driven by a motor during coating operation, and which generates a directing air flow, which during coating operation shapes the sprayed coating material to form a spray jet and deflects the same towards the workpiece to be coated,
wherein
measuring at least one pressure value, wherein said pressure value arises during the generation of the directing air flow in a vicinity of the directing air flow,
comparing the measured pressure value with a predetermined reference value, the redetermined reference value representing a flawless function of the rotary atomizer.

2-12. (canceled)

13. The method according to claim 1, wherein said pressure value arises within the directing air flow.

14. The method according to claim 1, wherein said pressure value arises in a region outside of the directing air flow, located in the vicinity of the directing air flow.

15. The method according to claim 1, wherein a pressure difference between a pressure within the directing air flow and a pressure in a region outside of the directing air flow is determined.

16. The method according to claim 1, wherein the pressure value is evaluated as a function of a parameter of the directing air flow measured per unit of time.

17. The method according to claim 13, wherein said parameter is at least one of a speed of the directing air flow and an air quantity of the directing air flow.

18. The method according to claim 13, wherein a progression of the pressure value is evaluated.

19. The method according to claim 1, wherein the at least one pressure value is measured with at least pressure sensor installed in the interior of the rotary atomizer.

20. The method according to claim 1, wherein the at least one pressure value is measured with at least one pressure sensor, which is arranged outside of the rotary atomizer at a defined position in relation to the rotary atomizer.

21. The method according to claim 1, wherein the pressure value is measured without coating material being sprayed by the spray body during measurement.

22. A coating installation for the series coating of workpieces with at least one rotary atomizer, which has a spray body, which can be rotated by a motor, and an annular arrangement of directing air openings for generating a directing air flow, which during coating operation shapes the sprayed coating material to form a spray jet and deflects the same in the direction of the workpiece to be coated,
wherein at least one pressure sensor is installed at a defined position in relation to the rotary atomizer, wherein said pressure sensor measures at least one pressure value which arises during the generation of the directing air flow in a region in the vicinity of the directing air flow.

23. The coating installation according to claim 22, wherein the pressure sensor is positioned in the interior of the rotary atomizer.

24. The coating installation according to claim 22, wherein the pressure sensor is positioned outside of the of the rotary atomizer.

25. The coating installation according to claim 24, wherein the at least one pressure sensor is fixed outside of the rotary atomizer at a fixed position within the spray booth.

26. The coating installation according to claim 25, wherein the at least one pressure sensors is fixed on a wall of a spray both in which the workpieces are coated.

27. The coating installation according to claim 22, wherein the at least one pressure sensor is arranged outside of the rotary atomizer on an automatic coating machine, which carries and moves the rotary atomizer.

28. The coating installation according to claim 27, wherein the automatic coating machine is a coating robot.

29. The coating installation according to claim 22, wherein the pressure sensor is movable and provided outside of the rotary atomizer, wherein the movable pressure sensor can be brought into a defined position with respect to the rotary atomizer.

30. The coating installation according to claim 29, wherein the movable pressure sensor is moved manually.

31. The coating installation according to claim 29, wherein the movable pressure sensor is moved by an automatically controlled handling device.

32. A rotary atomizer of the coating installation according to claim 22, with at least one pressure sensor, with which at least one pressure value of the directing air flow can be measured.
